(19) United States
(12) Patent Application Publication
(10) Pub. No.: US 2025/0018896 A1
(43) Pub. Date: Jan. 16, 2025

(54) PROXIMITY KEY JEWELRY

(71) Applicant: Lisa Kim Nelson, Chemainus (CA)

(72) Inventor: Lisa Kim Nelson, Chemainus (CA)

(21) Appl. No.: 18/351,052

(22) Filed: Jul. 12, 2023

(51) Int. Cl. B60R 25/24; A44C 15/00

(52) U.S. Cl. CPC B60R 25/24; A44C 15/00; B60R 2325/20

(57) ABSTRACT

A wearable proximity key that is provided in numerous decorative embodiments as a jewelry member wherein the wearable proximity key is configured to wirelessly communicate with a vehicle so as to transition the vehicle between a locked and unlocked state. The invention includes a jewelry member wherein the jewelry member can be embodied in numerous alternate types of wearable jewelry such as but not limited to a bracelet, necklace or belt buckle. The jewelry member includes a housing wherein the housing is an integral portion of the jewelry member. The housing has disposed therein a transceiver wherein the transceiver is configured to transmit and receive a wireless data signal. The transceiver is powered by a power supply that is releasably secured within the housing. The transceiver is communicably coupled with a vehicle and is operable to transition the vehicle between a locked state and an unlocked state.

### FIELD OF THE INVENTION

The present invention relates generally to security devices, more specifically but not by way of limitation, a proximity key for an object such as but not limited to an automobile, wherein the present invention is embodied in alternative forms of jewelry and wherein the present invention provides transmission of a wireless communication operable to be received by the object.

### BACKGROUND

Keyless entry for motor vehicles has become quite common with most new vehicles being manufactured with keyless entry and ignition. The transition from keyed ignition to keyless ignition has transpired over the last decade and is focused on potential increase in security as well as user convenience. Keyless entry employs a key fob wherein the key fob includes a power supply and a transmitter that is operable to transmit a wireless communication that is received by a receiver placed within the vehicle. A conventional key fob is typically anywhere from one to two inches in length and about an inch in width. Current technology employs key fobs that function as a technique to lock and unlock a vehicle as well as provide ignition of the vehicle.

One issue with the current technology of wireless key fobs is the size of the key fob itself. As most key fobs are quite large, their size makes it inconvenient to carry in pockets or items such as but not limited to small purses. Additionally, as conventional key fobs are loose items, they can commonly become lost which renders a vehicle inoperable until the key fob can be located.

Accordingly, there is a need for a proximity key fob configured to provide operation of a vehicle wherein the present invention provides a plurality of housing embodiments that are decorative jewelry wherein the housings can be worn by the user for use thereof.

### SUMMARY OF THE INVENTION

It is the object of the present invention to provide a proximity key having a housing that is designed to be wearable wherein the present invention is provided in a plurality of alternative embodiments for the housing thereof.

Another object of the present invention is to provide a wearable proximity key that is configured to provide operation of a vehicle wherein the housing of the present invention includes a power supply.

A further object of the present invention is to provide a proximity key having a housing that is designed to be wearable wherein the housing includes a transceiver disposed therein.

Yet a further object of the present invention is to provide a wearable proximity key that is configured to provide operation of a vehicle wherein the present invention is configured to communicably couple with a receiver in a vehicle.

Still another object of the present invention is to provide a proximity key having a housing that is designed to be wearable wherein housing embodiments can include but are not limited to bracelets, anklets, belt buckles and necklaces.

An additional object of the present invention is to provide a wearable proximity key that is configured to provide operation of a vehicle wherein the power supply is configured to be replaceable.

Yet a further object of the present invention is to provide a proximity key having a housing that is designed to be wearable wherein the transmitter can utilize various suitable wireless communication protocols.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

FIG. 2 is a perspective view of an embodiment of the present invention.

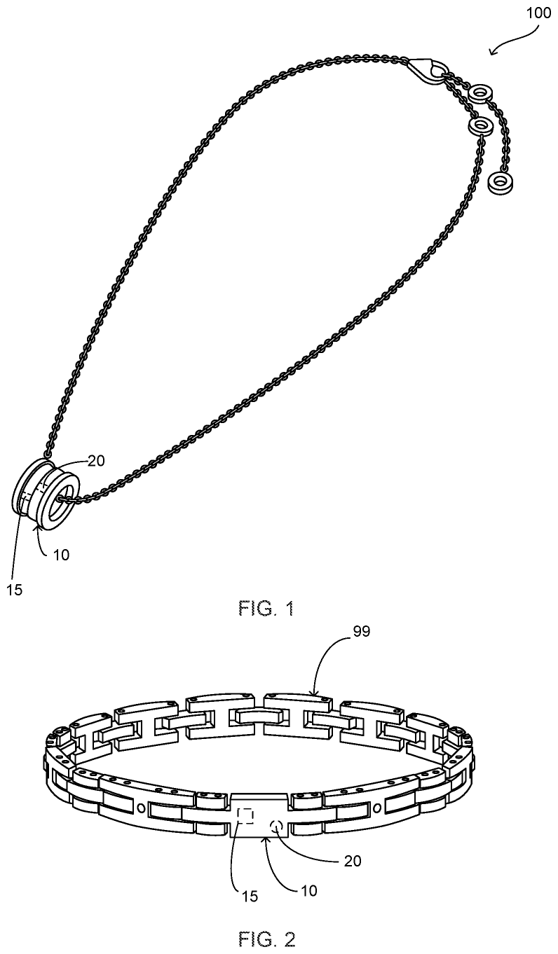

### DETAILED DESCRIPTION

Referring now to the drawings submitted herewith, wherein various elements depicted therein are not necessarily drawn to scale and wherein through the views and figures like elements are referenced with identical reference numerals, there is illustrated a wearable proximity key 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the wearable proximity key 100 is illustrated herein in alternative embodiments of an exemplary bracelet and a pendant necklace. It should be understood within the scope of the present invention that the wearable proximity key 100 could be manufactured in numerous alternative embodiments in addition to the embodiments illustrated herein. The wearable proximity key 100 includes a housing 10 wherein the housing 10 is a portion of the jewelry member 99. The housing 10 can be provided in alternate shapes and sizes and is constructed so as to be an integral portion of the jewelry member 99.

The housing 10 includes transceiver 15 wherein the transceiver 15 is internally located within the housing 10. The transceiver 15 includes the necessary electronics to receive, store, manipulate and transmit data signals. The transceiver 15 is configured to detect proximity to a vehicle (not illustrated herein) wherein the transceiver 15 is paired so as to be communicably coupled to the vehicle. The transceiver 15 is configured to transmit a wireless signal upon detection of being proximate a paired vehicle. The transceiver 15 initiates transmission of a data signal wherein upon being received by the vehicle the vehicle will transition from a locked state to an unlocked state so a user of the wearable proximity key 100 can access the interior of the vehicle. It should be understood within the scope of the present invention that the transceiver 15 could employ various wireless communication protocols to wirelessly communicate with the vehicle. It should be further understood within the scope of the present invention that the wearable proximity key 100 transitions the vehicle to a locked state upon detection by the vehicle that the wearable proximity key 100 has been removed from the proximity of the vehicle.

The housing 10 further includes a power supply 20. The power supply 20 is releasably secured within the housing 10 and is operably coupled to the transceiver 15. The power supply 20 provides the necessary power for operation of the transceiver 15. The power supply 20 is releasably coupled within the housing 10 so as to be replaceable. While various types of power supplies could be utilized, it is contemplated within a preferred embodiment of the present invention that the power supply 20 is a lithium ion battery. It should be further understood that the power supply 20 could be rechargeable wherein the jewelry member 99 could be superposed a magnetic induction charger so as to provide recharging of the power supply 20.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A wearable proximity key that is communicably coupled to a vehicle so as to execute a first task and a second task wherein the wearable proximity key comprises:
a jewelry member, said jewelry member being configured to be worn by a user, said jewelry member being provided in a multitude of embodiments;
a housing, said housing being an integral portion of said jewelry member;
a transceiver, said transceiver being disposed within said housing, said transceiver having electronics to receive, store, manipulate and transmit a data signal; and
wherein the first task and second task are executed based upon a distance between the wearable proximity key and the vehicle.

2. The wearable proximity key that is communicably coupled to the vehicle as recited in claim 1, wherein the first task is unlocking the vehicle, wherein the first task is executed upon the transceiver being proximate the vehicle.

3. The wearable proximity key that is communicably coupled to the vehicle as recited in claim 2, and further including a power supply, said power supply being releasably secured within said housing, said power supply being operably coupled to said transceiver.

4. The wearable proximity key that is communicably coupled to the vehicle as recited in claim 3, wherein the second task is locking the vehicle, wherein the second task is executed upon the transceiver leaving proximity of the vehicle.

5. The wearable proximity key that is communicably coupled to the vehicle as recited in claim 4, wherein the jewelry member is embodied from a group selected of one of the following embodiments: bracelet, ring, anklet, necklace, belt buckle or pin.
